(19) United States
(12) Patent Application Publication
(10) Pub. No.: US 2024/0243448 A1
(43) Pub. Date: Jul. 18, 2024

(54) ENERGY STORAGE APPARATUS, AND METHOD OF CONTROLLING CURRENT INTERRUPTION DEVICE

(71) Applicant: GS Yuasa International Ltd., Kyoto-shi, Kyoto (JP)

(72) Inventors: Yu MATSUMOTO, Kyoto (JP); Masaki OYA, Kyoto (JP)

(21) Appl. No.: 18/560,289

(22) PCT Filed: Mar. 17, 2022
(86) PCT No.: PCT/JP2022/012273

§ 371 Date: Nov. 10, 2023

(30) Foreign Application Priority Data
May 13, 2021 (JP) 2021-081697

(51) Int. Cl. H01M 50/574; B60R 16/033; H01M 10/42; H02J 7/00

(52) U.S. Cl. CPC H01M 50/574; B60R 16/033; H01M 10/425; H02J 7/0029; H01M 2010/4271; H01M 2010/4278; H01M 2220/20

(57) ABSTRACT

An in-vehicle energy storage apparatus 50 includes: an energy storage cell 62; a current interruption device 53 configured to interrupt a current to the energy storage cell 62; and a control unit 130, wherein the control unit 130 is configured to, in a case where the energy storage apparatus 50 is charged with electricity in a not-in-vehicle state, interrupt the current to the energy storage cell 62 by the current interruption device 53 after the energy storage apparatus 50 is charged with electricity.

### TECHNICAL FIELD

The present invention relates to a technique for reducing a risk of occurrence of an external short circuit.

### BACKGROUND ART

An in-vehicle energy storage apparatus includes a current interruption device as one of protective devices for protecting the energy storage apparatus. When an abnormality such as an external short circuit is detected, the current interruption device is opened so as to interrupt an electric current thus protecting the energy storage apparatus (see patent Document 1).

### PRIOR ART DOCUMENT

### Patent Document

Patent Document 1: JP-A-2017-5985

### SUMMARY OF THE INVENTION

### Problems to be Solved by the Invention

The energy storage apparatus that is charged with electricity exhibits a higher state of charge (SOC) than the state of charge before charging. Accordingly, in a case where a current interruption device cannot be opened when an external short circuit occurs, a short-circuit current flows continuously for a long time. When a short-circuit current flows continuously for a long time, there is a concern that heat is generated in an energy storage apparatus and in components of the energy storage apparatus such as bus bars so that the energy storage apparatus is damaged.

In order to enhance safety of the energy storage apparatus, it is desirable that an external short circuit do not occur in the energy storage apparatus that is charged with electricity.

### Means for Solving the Problems

An in-vehicle energy storage apparatus according to an aspect of the present invention includes: an energy storage cell; a current interruption device configured to interrupt a current to the energy storage cell; and a control unit. The control unit is configured to, in a case where the energy storage apparatus is charged with electricity in a not-in-vehicle state, interrupt the current to the energy storage cell by the current interruption device after the energy storage apparatus is charged with electricity. This technique may be implemented as a method for controlling the current interruption device.

### Advantages of the Invention

According to the above-mentioned aspect, it is possible to reduce the risk of the occurrence of an external short circuit.

### BRIEF DESCRIPTION OF THE DRAWINGS

FIG. 1 is a side view of an automobile.

FIG. 2 is a block diagram illustrating the electrical configuration of the automobile.

FIG. 3 is an exploded perspective view of a battery.

FIG. 4 is a plan view of a secondary battery cell.

FIG. 5 is a cross-sectional view of the secondary battery cell taken along a line A-A in FIG. 4.

FIG. 6 is a block diagram showing an electrical configuration of the battery.

FIG. 7 is a block diagram illustrating a current path of a short-circuit current.

FIG. 8 is a diagram illustrating a change in state of a relay.

FIG. 9 is a block diagram illustrating a current path of a charge current.

FIG. 10 is a flowchart of processing for reducing the risk of the occurrence of an external short circuit.

FIG. 11A is a table illustrating a charging history stored in a memory.

FIG. 11B is a table illustrating a charging history stored in the memory.

FIG. 12 is a flowchart of processing for reducing the risk of the occurrence of an external short circuit.

FIG. 13 is a flowchart of recovery processing.

FIG. 14 is a block diagram illustrating the electrical configuration of a battery.

FIG. 15 is a diagram illustrating a change in state of a relay.

FIG. 16 is a diagram illustrating a change in state of a relay.

### MODE FOR CARRYING OUT THE INVENTION

An overall configuration of an in-vehicle energy storage apparatus according to an embodiment of the present invention will be described.

The in-vehicle energy storage apparatus includes: an energy storage cell; a current interruption device that interrupts a current to the energy storage cell; and a control unit. In a case where the energy storage apparatus is charged with electricity in a state where the energy storage apparatus is in a not-in-vehicle state, the control unit interrupts the current to the energy storage cell by the current interruption device after the energy storage apparatus is charged with electricity.

When the energy storage apparatus is in a not-in-vehicle state, it is considered that the energy storage apparatus is not in a state that the energy storage apparatus is immediately used (the energy storage apparatus not being in a state where the energy storage apparatus receives charging of electricity from a vehicle generator or not being in a state where the energy storage apparatus discharges electricity to a vehicle electrical load). In a case where the energy storage apparatus is charged with electricity in a state where the energy storage apparatus is in a not-in-vehicle state, the current interruption device is opened after the energy storage apparatus is charged with electricity so as to interrupt the current to the energy storage cell. The energy storage apparatus is charged with electricity to a high state of charge (SOC) (for example, 100%) immediately before the energy storage apparatus is mounted on the vehicle. After the completion of such charging of electricity, the current interruption device that the energy storage apparatus includes is opened. Alternatively, the energy storage apparatus may be charged with electricity to a certain level of SOC immediately before the energy storage apparatus is shipped from a manufacturer (for example, a factory) of the energy storage apparatus and, thereafter, the current interruption device that the energy storage apparatus includes may be opened.

By interrupting the current, even if an object that may cause a short circuit such as a tool is brought into contact with an external terminal of the energy storage apparatus at the time of mounting the energy storage apparatus that is charged with electricity on the vehicle, a short-circuit current does not flow into the object. Accordingly, it is possible to reduce a risk that the energy storage apparatus after being charged with electricity causes an external short circuit. In the same manner, it is possible to reduce the risk of occurrence of an external short circuit even during storing or transportation of the energy storage apparatus after being charged with electricity.

The control unit may determine whether the energy storage apparatus is in an in-vehicle state or in a not-in-vehicle state after being charged with electricity. With such a configuration, when the energy storage apparatus is mounted on the vehicle immediately before the energy storage apparatus is charged with electricity, it is possible to prevent the energy storage apparatus after being charged with electricity from being erroneously determined as “in a not-in-vehicle state”.

The control unit may determine whether the energy storage apparatus is in an in-vehicle state or in a not-in-vehicle state based on the communication with the vehicle. When the energy storage apparatus can communicate with the vehicle, it is considered that the energy storage apparatus is mounted on the vehicle and is in use. With such a configuration, it is possible to prevent the occurrence of a case where the energy storage apparatus that is mounted on the vehicle and is in use is erroneously determined as “in a not-in-vehicle state”.

In a case where the energy storage apparatus to which the supply of a current is interrupted is mounted on the vehicle, the control unit may release the interruption of the current by the current interruption device. With such a configuration, it is unnecessary to perform an operation of releasing the interruption of the current after the energy storage apparatus is mounted on the vehicle. Accordingly, it is possible for an operator to save the time and efforts in an operation of mounting the energy storage apparatus on the vehicle.

### Embodiment 1

### 1. Description of Automobile 10

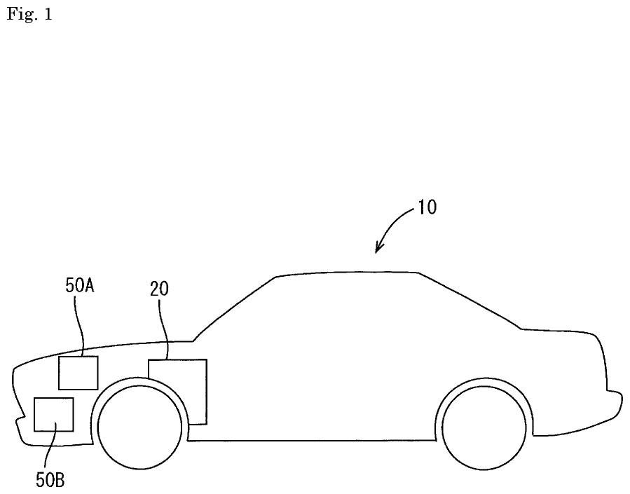

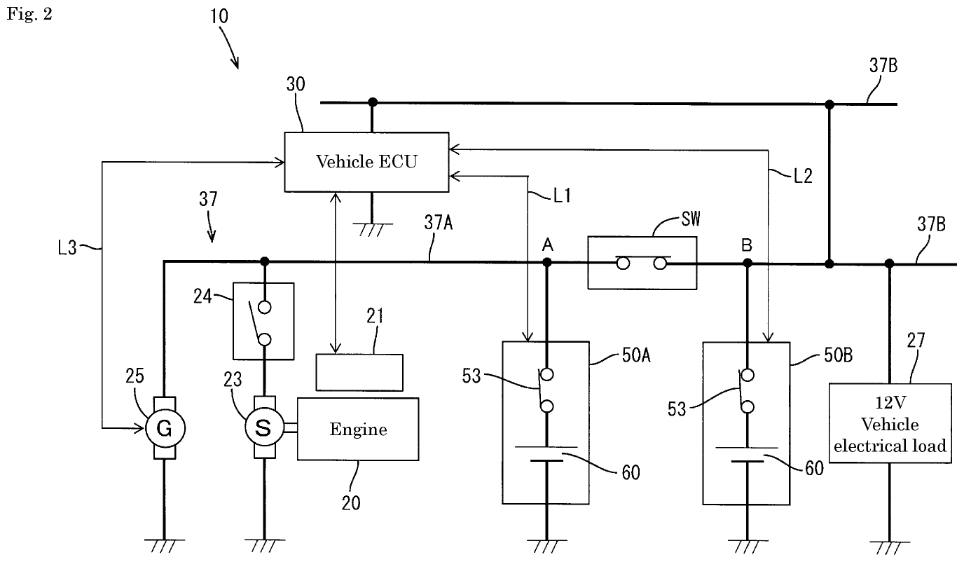

FIG. 1 is a side view of an automobile 10 as an example of a vehicle, and FIG. 2 is a block diagram illustrating an electrical configuration of the automobile 10.

The automobile 10 includes: an engine 20 that is a driving device; an engine control unit 21; an engine starting device 23; an alternator 25; a vehicle electrical load 27; a vehicle electronic control unit (ECU) 30; a first battery 50A; and a second battery 50.

The first battery 50A is connected to a point A of a power supply line 37. The second battery 50B is connected to a point B of the power supply line 37.

A switch SW is provided between the point A and the point B. By closing the switch SW, two batteries 50A, 50B can be connected to each other in parallel. By opening the switch SW, two batteries 50A, 50B can be disconnected from each other. The switch SW may be omitted or may be replaced with other configurations.

With respect to the power supply line 37, the engine starting device 23 and the alternator 25 are connected to a power supply line 37A to which the first battery 50A is connected.

The engine starting device 23 includes a starter motor. When an ignition switch 24 is turned on, a cranking current flows from the first battery 50A (or the second battery 50B), and the engine starting device 23 is driven. A crankshaft is rotated by driving the engine starting device 23 so that the engine 20 is started. The first battery 50A functions as a battery for starting the engine 20. In a case where the vehicle can start traveling by the driving energy storage apparatus (the high-voltage battery) instead of an internal combustion engine, the first battery 50A supplies electricity for starting the driving energy storage apparatus.

The alternator 25 is a vehicle generator that generates electricity using power of the engine 20. In a case where a power generation amount of the alternator 25 exceeds an electric load amount of the automobile 10, electricity is charged to the first battery 50A and the second battery 50B from the alternator 25. In a case where a power generation amount of the alternator 25 is smaller than an electric load amount of the automobile 10, electricity is discharged from the first battery 50A and the second battery 50B to compensate for a shortage of the power generation amount.

The vehicle electrical load 27 and the vehicle ECU 30 are connected to a power supply line 37B of the power supply line 37 to which the second battery 50B is connected. The vehicle electrical load 27 and the vehicle ECU 30 are operated using the second battery 50B as a power source even in a case where the first battery 50A is in a not-in-vehicle state or even in a case where the switch SW is opened. The second battery 50B functions as a redundant battery.

The vehicle electrical load 27 has a rated voltage of 12V. The vehicle electrical load 27 is an auxiliary device such as an air conditioner, an audio system, or a car navigation system.

The vehicle ECU 30 performs the power source management of the automobile 10. The vehicle ECU 30 is communicably connected to the first battery 50A and the second battery 50B via communication lines L1 and L2. Further, the vehicle ECU 30 is communicably connected to the alternator 25 via a communication line L3.

The vehicle ECU 30 receives information relating to states of charge (SOCs) from two batteries 50A, 50B, and controls a power generation amount of the alternator 25 thus controlling states of charge (SOCs) of two batteries 50A, 50B.

### 2. Description of First Battery 50A

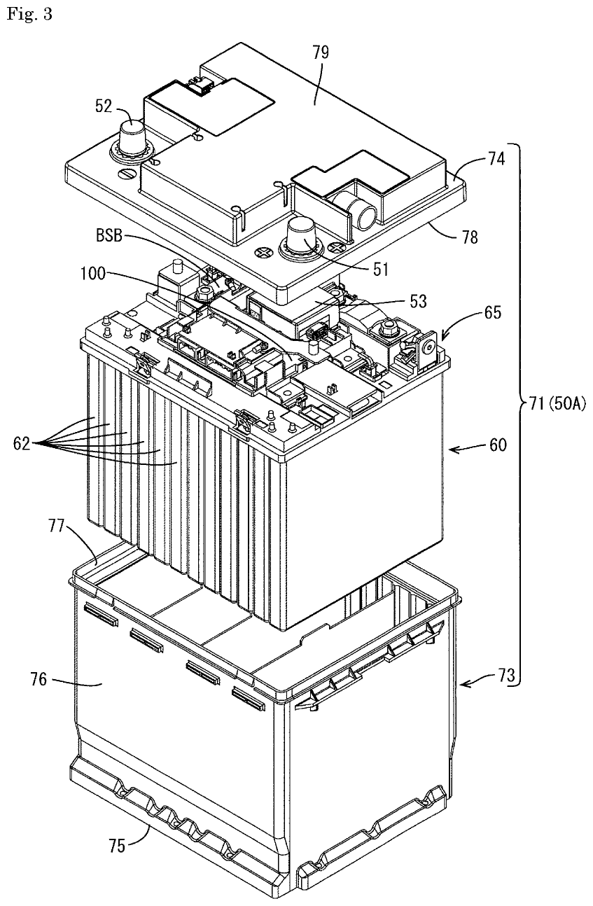

Hereinafter, the structure of the first battery 50A will be described with reference to FIG. 3 to FIG. 5.

The first battery 50A illustrated in FIG. 3 includes an assembled battery 60, a circuit board unit 65, and a container 71 that is a housing. The container 71 includes a body 73 made of a synthetic resin material, and a lid body 74. The body 73 has a bottomed cylindrical shape. The body 73 includes a bottom surface portion 75 and four side surface portions 76. An upper opening portion 77 is formed at an upper end portion of the body 73 by four side surface portions 76.

The container 71 contains the assembled battery 60 and the circuit board unit 65. The circuit board unit 65 is a board unit where various components (a relay 53, a current detection unit 54, a management device 110 and the like) are mounted on a circuit board 100. The circuit board unit 65 is disposed on an upper portion of the assembled battery 60.

The lid body 74 closes the upper opening portion 77 of the body 73. An outer peripheral wall 78 is formed on a periphery of the lid body 74. The lid body 74 has a protruding portion 79 having an approximately T shape as viewed in a plan view. On a front portion of the lid body 74, an external terminal 51 of a positive electrode is fixed to one corner portion, and an external terminal 52 of a negative electrode is fixed to the other corner portion.

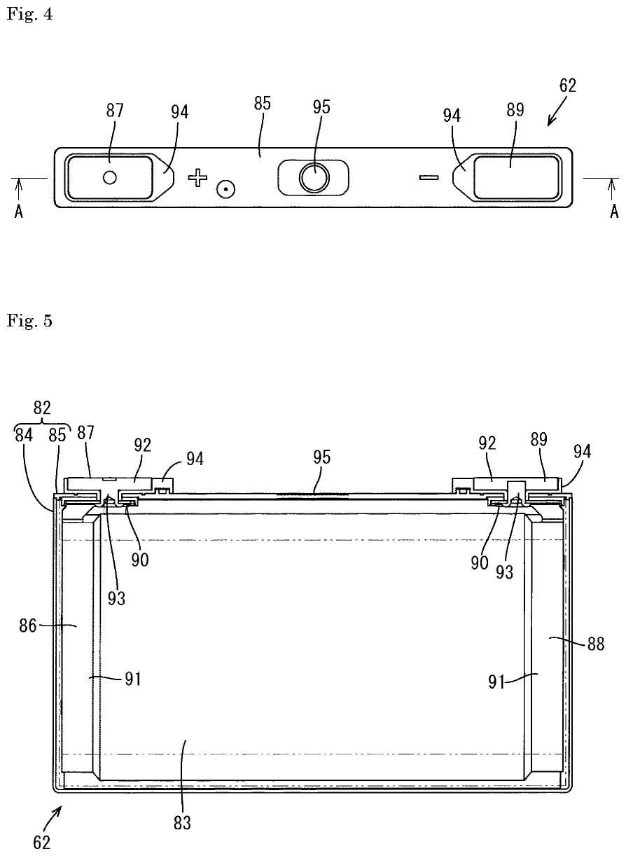

The assembled battery 60 is formed of a plurality of secondary battery cells 62. As illustrated in FIG. 4 and FIG. 5, the secondary battery cell 62 is configured such that an electrode assembly 83 is housed in a case 82 having a rectangular parallelepiped shape together with a nonaqueous electrolyte. As an example of the secondary battery cell 62, a lithium ion secondary battery cell is named. The case 82 includes: a case body 84; and a lid 85 that closes an opening portion formed at an upper portion of the case body 84.

Although not illustrated in detail, the electrode assembly 83 is formed such that a separator formed of a porous resin film is disposed between a negative electrode element that is formed by applying an active material to a substrate formed of a copper foil, and a positive electrode element that is formed by applying an active material to a substrate formed of an aluminum foil. These elements all have a strip shape, and are wound in a flat shape so as to be accommodated in the case body 84 in a state where the position of the negative electrode element and the position of the positive electrode element are displaced toward opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each formed of: a pedestal portion 90 having a flat plate shape; and a leg portion 91 extending from the pedestal portion 90. A through hole is formed in the pedestal portion 90. The leg portion 91 is connected to the positive electrode element or the negative electrode element.

The positive electrode terminal 87 and the negative electrode terminal 89 each include: a terminal body portion 92; and a shaft portion 93 protruding downward from a center portion of a lower surface of the terminal body portion 92. In such a configuration, the terminal body portion 92 and the shaft portion 93 of the positive electrode terminal 87 are integrally formed with each other using aluminum (a single material). In the negative electrode terminal 89, the terminal body portion 92 is made of aluminum, and the shaft portion 93 is made of copper. The negative electrode terminal 89 is formed by assembling the terminal body portion 92 and the shaft portion 93 to each other. The terminal body portion 92 of the positive electrode terminal 87 and the terminal body portion 92 of the negative electrode terminal 89 are disposed at both end portions of the lid 85 via gaskets 94 made of an insulating material, and are exposed outward from the gaskets 94.

The lid 85 has a pressure release valve 95. The pressure release valve 95 is positioned between the positive electrode terminal 87 and the negative electrode terminal 89. The pressure release valve 95 is released so as to lower the internal pressure in the case 82 when an internal pressure in the case 82 exceeds a limit value.

The secondary battery cell 62 is not limited to a prismatic cell, and may be a cylindrical cell or a pouch cell having a laminate case.

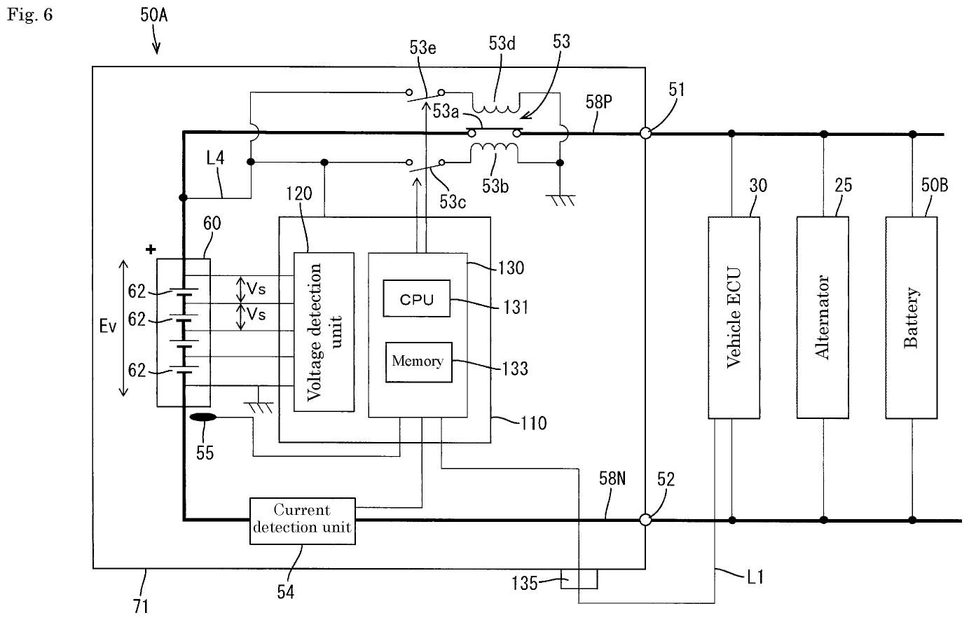

FIG. 6 is a block diagram illustrating an electrical configuration of the first battery 50A. The first battery 50A includes the assembled battery 60, the relay 53, the current detection unit 54, a temperature sensor 55 and a management device 110.

The assembled battery 60 is formed of a plurality of secondary battery cells 62. Twelve secondary battery cells 62 are connected with each other in three parallels and four series.

In FIG. 6, three secondary battery cells 62 that are connected in parallel to each other are each indicated by one battery symbol. The secondary battery cell 12 is an example of the “energy storage cell”. In this embodiment, the first battery 50A is a so-called low-voltage battery, and has a rated voltage of 12V.

The assembled battery 60, the relay 53, and the current detection unit 54 are connected in series via a power line 58P and a power line 58N. As the power lines 58P and 58N, a bus bar BSB that is a plate-like conductor made of a metal material such as copper can be used.

The power line 58P connects the external terminal 51 of the positive electrode and the positive electrode of the assembled battery 60 to each other. The power line 58N connects the external terminal 52 of the negative electrode and the negative electrode of the assembled battery 60 to each other.

The external terminals 51, 52 are terminals for connecting the first battery 50A to the automobile 10. The engine starting device 23 and the alternator 25 can be electrically connected to the first battery 50A via the external terminals 51, 52.

The relay 53 (an example of a current interruption device) is provided to the power line 58P of the positive electrode.

In this embodiment, the relay 53 is a latch relay. The relay 53 includes a contact 53a, a setting drive coil 53b, a switch 53c, a resetting drive coil 53d, and a switch 53e. The relay 53 is connected to the positive electrode of the assembled battery 60 via a power supply line L4, and is operated using the assembled battery 60 as a power source.

When a current is supplied to the setting drive coil 53b from the assembled battery 60 by closing the switch 53c, a state where the contact 53a is closed (a closed state) can be held. When a current is supplied to the resetting drive coil 53d from the assembled battery 60 by closing the switch 53e, a state where the contact 53a is opened (an open state) can be held.

The relay 53 is normally closed, and hence, the contact 53a is held in a closed state normally. When an abnormality such as an external short circuit occurs, a current is supplied to the resetting drive coil 53d so as to hold a state where the contact 53a is opened (an open state). Accordingly, a current to the first battery 50A can be interrupted. The relay 53 is a protective device for securing safety of the battery 50.

The current detection unit 54 is provided to the power line 58N of the negative electrode. The current detection unit 54 measures a current I of the assembled battery 60. The current detection unit 54 may be a shunt resistor. The current detection unit 54 of a resistance type can determine discharging and charging of electricity based on the polarity (positive or negative) of a voltage. The temperature sensor 55 is a contact type sensor or a non-contact type sensor, and measures temperatures T [° C.] of the assembled battery 60.

The management device 110 is mounted on the circuit board 100, and includes a voltage detection unit 120 and a control unit 130. The management device 110 is connected to the positive electrode of the assembled battery 60 by the power supply line L4, and is operated using the assembled battery 60 as a power source.

The voltage detection unit 120 is connected to both ends of each secondary battery cell 62 by a signal lines, and measures a cell voltage Vs of each secondary battery cell 62. Further, the voltage detection unit 120 measures a total voltage Ev of the assembled battery 60 based on cell voltages Vs of the respective secondary battery cells 62. The total voltage Ev of the assembled battery 60 is a sum of the voltages of four secondary battery cells 62 connected in series.

The control unit 130 includes a CPU 131 and a memory 133. The control unit 130 monitors a state of the first battery 50A based on outputs of the current detection unit 54, the voltage detection unit 120, and the temperature sensor 55. That is, the control unit 130 monitors a current I, a total voltage Ev, and a temperature T of the assembled battery 60.

The memory 133 stores a monitoring program for monitoring a state of the first battery 50A and a control program of the relay 53. In the memory 133, data necessary for executing these programs is stored. The program can be stored in a recording medium such as a CD-ROM and can be transferred. The program can also be distributed using an electric communication line.

The management device 110 is connected to the vehicle ECU 30 via a communication connector 135 and the communication line L1, and communicates with the vehicle ECU 30 via CAN communication or LIN communication. The control unit 130 can receive information relating to an operation and a non-operation of the engine 20 from the vehicle ECU 30. Further, the control unit 130 exchanges information with the vehicle ECU 30 by communication about a situation of a progress of charging of electricity (for example, an SOC or a total voltage) during charging electricity to the first battery 50A.

The second battery 50B may have the same structure as the first battery 50A or the different structure from the first battery 50A. In the description made hereinafter, the first battery 50A and the second battery 50B are collectively referred to as the battery 50.

### 2. Reduction of Risk of Occurrence of External Short Circuit

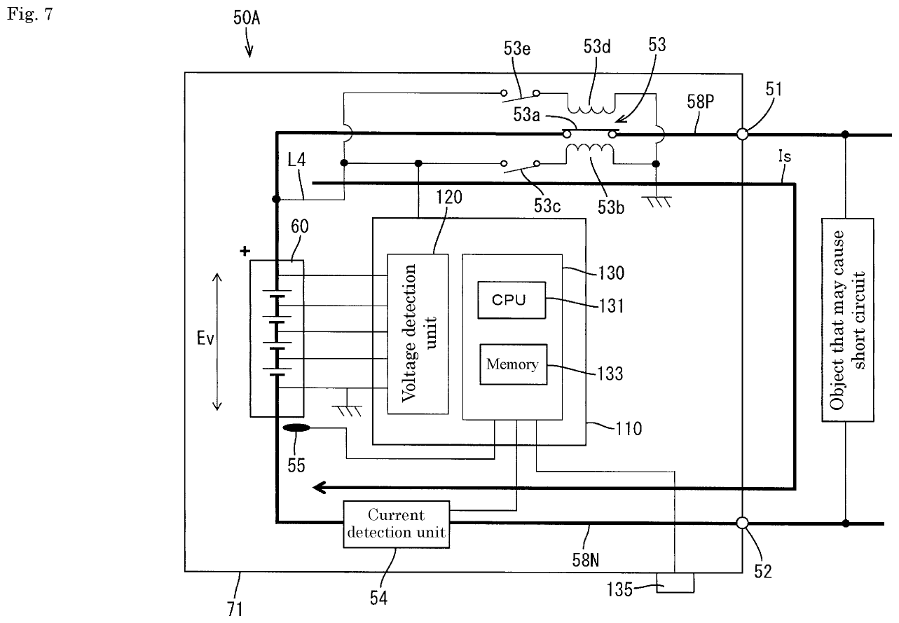

When a metal piece is brought into contact with the external terminals 51, 52, a short-circuit current Is flows to the battery 50 (FIG. 7: an external short circuit).

When an external short circuit is detected, the short-circuit current Is can be interrupted by opening the relay 53. However, the short-circuit current Is is a large current and hence, a voltage drop due to an internal resistance of the assembled battery 60 is large. Accordingly, there is a concern that the assembled battery 60 cannot maintain a drive voltage of the relay 53. When the drive voltage cannot be maintained, the relay 53 cannot be opened and hence, there is a concern that the short-circuit current Is continuously flows.

In particular, assume a case where an external short circuit occurs in the battery 50 that is in a state where an SOC after the energy storage apparatus is charged with electricity is high so that the relay 53 cannot be opened. In this case, the short-circuit current Is continues to flow for a long time. Accordingly, there is a concern that the battery 50, a bus bar BSB, the relay 53, and the like are damaged by heat generated in these components.

It is considered that the occurrence of an external short circuit is highly likely to take place in the following two cases.
(1) A case where a tool (metal) is brought into contact with the external terminals 51, 52 during a shipping step from a manufacturer or during storing of the battery 50 after being charged with electricity at a vehicle dealer (a car dealer).
(2) A case where a tool (metal) or a body of an automobile is brought into contact with the external terminals 51, 52 when the battery 50 is removed from the automobile 10, the battery 50 is charged with electricity by an external charger and, then, the battery 50 is returned to the automobile 10.

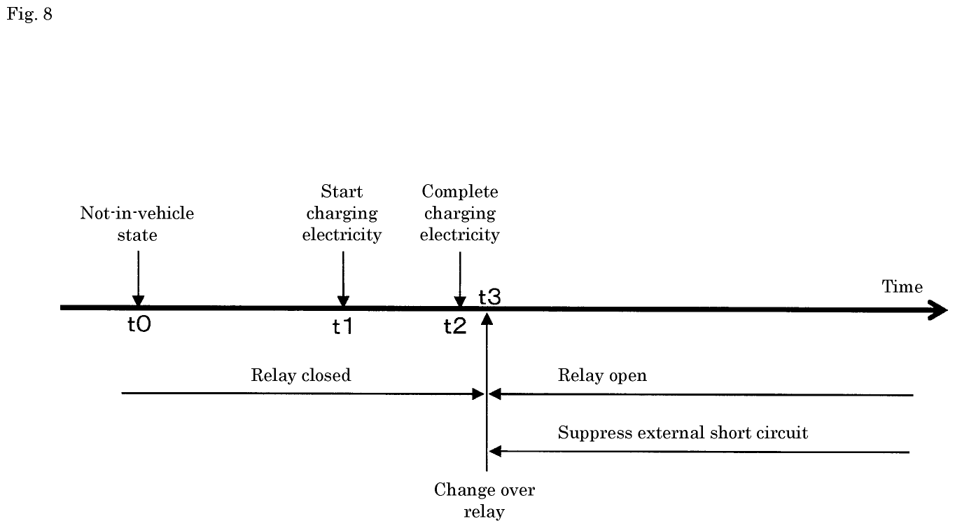

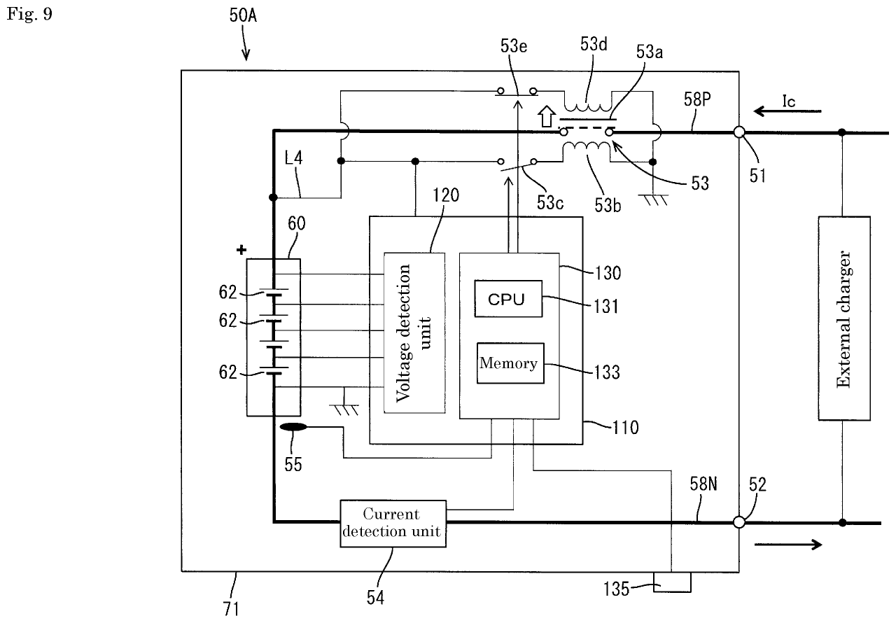

In a case where the battery 50 is in a not-in-vehicle state, it is considered that the battery 50 is not in a state of being immediately used. Accordingly, in a case where the battery 50 in a not-in-vehicle state that is likely not to be used immediately is charged with electricity, the relay 53 is opened (FIG. 8 and FIG. 9) after charging of the battery 50 with electricity is completed, and the relay 53 is held in this open state.

By opening the relay 53, even in a case where an object that may cause a short circuit such as a tool is brought into contact with the external terminals 51, 52, a short-circuit current Is does not flow. Accordingly, it is possible to reduce a risk that the battery 50 after being charged with electricity causes an external short circuit.

The control unit 130 can determine whether or not the battery 50 is mounted on the vehicle via communication between the control unit 130 and the vehicle ECU 30. For example, in a case where there is communication between the control unit 130 and the vehicle ECU 30 during charging of electricity, the control unit 130 determines that the battery 50 is “in an in-vehicle state”. For example, in a case where there is no communication between the control unit 130 and the vehicle ECU 30 during charging of electricity, the control unit 130 determines that the battery 50 is “in a not-in-vehicle state”.

### 3. Description of Processing for Reducing Risk of Occurrence of External Short Circuit

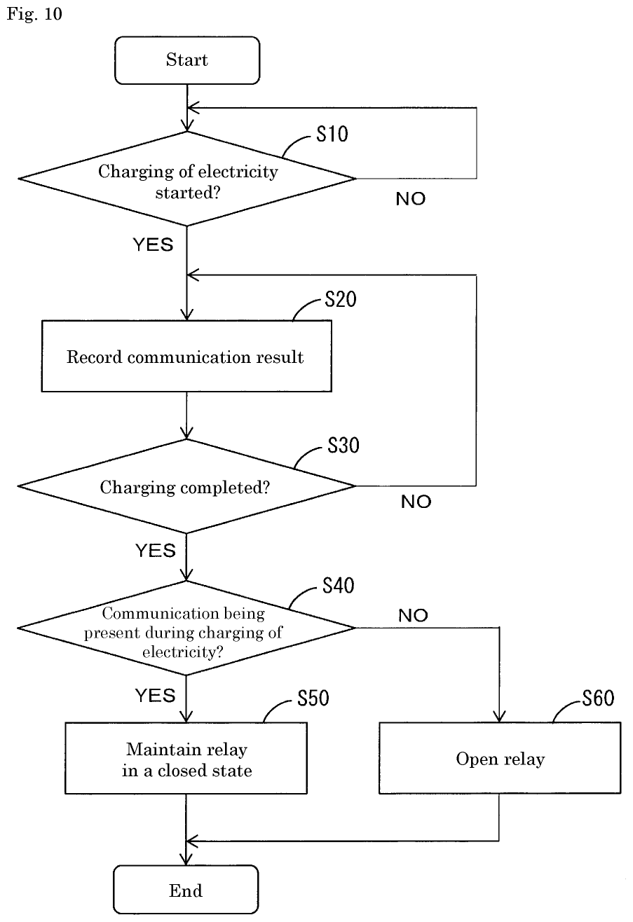

FIG. 10 is a flowchart of processing for reducing the risk of occurrence of an external short circuit. Hereinafter, the processing for reducing the risk of occurrence of an external short circuit is described with respect to the first battery 50A. It is assumed that the first battery 50A is controlled to be in a “closed state” at a point of time that the processing for reducing the risk of occurrence of an external short circuit is started.

The processing for reducing the risk of occurrence of an external short circuit is processing that is constituted of steps S10 to S60, and is performed at a predetermined cycle in parallel with the monitoring of the state of the first battery 50A during the activation of the management device 110.

After the activation of the management device 110, the control unit 130 advances processing to step S10 where the control unit 130 determines whether or not charging of electricity is started. The control unit 130 can determine the starting of charging of electricity based on the presence or the non-presence of a charge current Ic. The charge current Ic can be measured by the current detection unit 54.

When the current detection unit 54 detects the starting of charging of electricity, the control unit 130 advances the processing to step S20, and records the communication history during charging of electricity in the memory 133. The communication history includes a charging start time, a record of communications during charging, and a charging completion time.

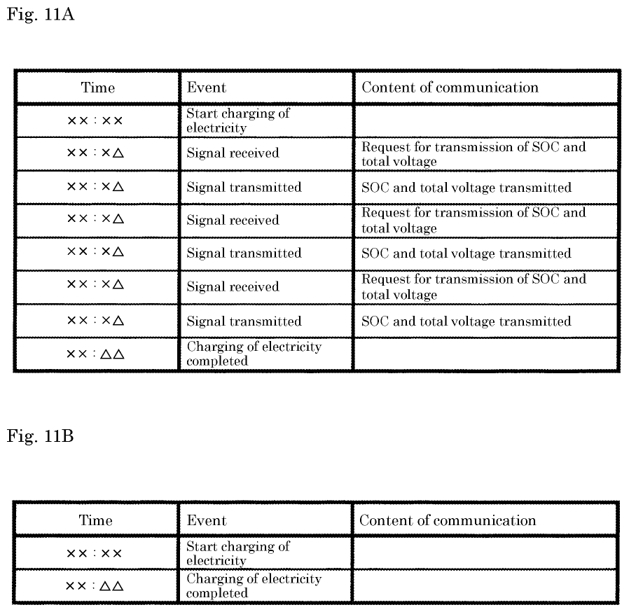

The record of communications during charging electricity is a record of communications performed between the control unit 130 and the vehicle ECU 30 during charging of electricity, and includes times at which communication is made, the contents of communications (the record of transmissions and the receptions of an SOC and a total voltage) and the like. FIG. 11A is a communication history (charging of electricity being performed by the alternator) in a case where the first battery 50A is charged with electricity in a state where the first battery 50A is in an in-vehicle state. FIG. 11B is a communication history (charging of electricity being performed by an external charger) in a case where the first battery 50A is charged with electricity in a not-in-vehicle state.

Then, the processing advances to S30, and the control unit 130 determines whether or not charging of electricity is completed. The control unit 130 can determine the completion of charging of electricity based on the presence or the non-presence of a charge current Ic. That is, in a case where a charge current Ic is no longer measured by the current detection unit 54, the control unit 130 determines that the charging of electricity is completed. The SOC of the energy storage apparatus at the time of completion of charging of electricity may be 100% or 100% or less.

When the control unit 130 detects the completion of charging of electricity, the control unit 130 advances the processing to step S40, and determines whether or not there is communication between the control unit 130 and the vehicle ECU 30 during charging of electricity. The control unit 130 can determine the presence or the non-presence of communication by referencing communication history during charging of electricity through an access to the memory 133.

In the case where the control unit 130 determines that there is communication between the control unit 130 and the vehicle ECU 30 during charging of electricity (in the case illustrated in FIG. 11A), the control unit 130 determines that the first battery 50A is “in an in-vehicle state”. In this case, the control unit 130 maintains the relay 53 “in a closed state” (S50).

In the case where the control unit 130 determines that there is no communication between the control unit 130 and the vehicle ECU 30 during charging of electricity (in the case illustrated in FIG. 11B), the control unit 130 determines that the first battery 50A is “in a not-in-vehicle state”. In this case, the control unit 130 opens the relay 53 in an “open” state (S60).

### 4. Description of Advantageous Effects

According to the present embodiment, in a case where the battery 50 is in a not-in-vehicle state, the control unit 130 considers that the battery 50 is not in a state of being immediately used, and opens the relay 53 after charging of electricity is completed.

A current is interrupted by the opening of the relay 53. Accordingly, even if an object that may cause a short circuit such as a tool is brought into contact with the external terminals 51, 52 when the battery 50 that is charged with electricity is placed on the automobile 10, a short-circuit current Is does not flow.

Accordingly, it is possible to reduce a risk that the battery 50 after being charged with electricity causes an external short circuit. In the same manner, it is possible to reduce the risk of occurrence of an external short circuit in the battery 50 by interrupting a current after being charged with electricity even during storing or transportation of the battery 50 after being charged with electricity.

The control unit 130 determines whether or not the battery 50 is “in an in-vehicle state” or “in a not-in-vehicle state” after charging of the battery 50 with electricity is completed (S40). With such a configuration, when the battery 50 is mounted on the vehicle immediately before being charged with electricity, it is possible to prevent the battery 50 after being charged with electricity from being erroneously determined as “in a not-in-vehicle state”.

The control unit 130 determines whether the battery 50 is “in an in-vehicle state” or is in a not-in-vehicle” state via communication with the automobile 10. When there is communication between the battery 50 and the automobile 10, it is considered that the battery 50 is in an in-vehicle state and is in use. With such a configuration, it is possible to prevent the occurrence of a case where the battery 50 that is in an in-vehicle state and is in use is erroneously determined that the battery 50 is “in a not-in-vehicle state”.

### Embodiment 2

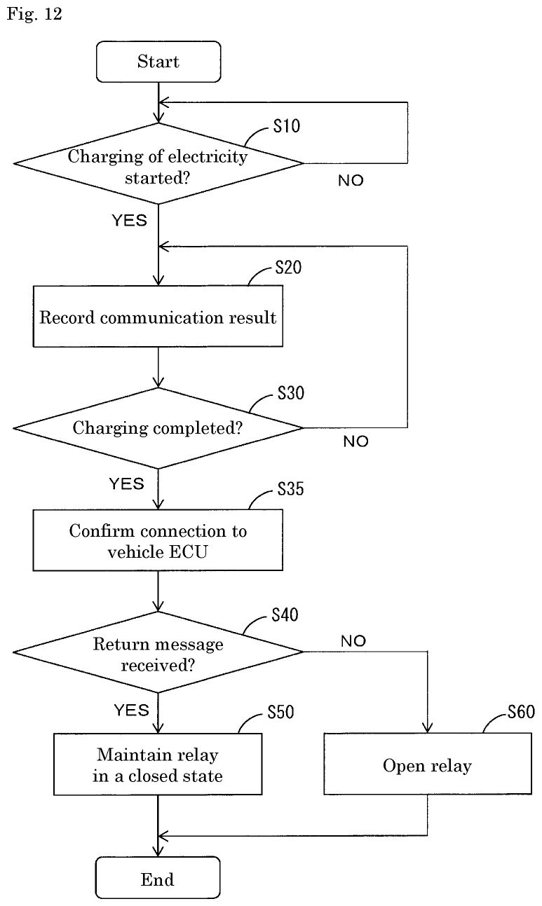

FIG. 12 is a flowchart of processing for reducing the risk of occurrence of an external short circuit.

The processing for reducing the risk of occurrence of an external short circuit illustrated in FIG. 12 differs from the processing illustrated in FIG. 10 in that a notification for requesting the confirmation of connection is transmitted from the first battery 50A to the vehicle ECU 30 after the completion of charging of electricity (S35).

When the first battery 50A is mounted on the vehicle and can communicate with the vehicle ECU 30, the vehicle ECU 30 receives a notification of the confirmation of the connection transmitted from the first battery 50A. Upon receiving the notification from the first battery 50A, the vehicle ECU 30 returns a notification of confirmation of the reception to the first battery 50A.

When there is a return message of the confirmation of the connection from the vehicle ECU 30 (S40: YES), the control unit 130 determines that the first battery 50A is “in an in-vehicle state”. In this case, the control unit 130 maintains the relay 53 “in a closed” state” (S50).

On the other hand, when there is no return message of the confirmation of the connection from the vehicle ECU 30 (S40: YES), the control unit 130 determines that the first battery 50A is not “in an in-vehicle state”. In this case, the control unit 130 opens the relay 53 (S60).

According to embodiment 2, in the same manner as embodiment 1, in a case where the battery 50 is in a not-in-vehicle state after the completion of charging of electricity, the control unit 130 considers that the battery 50 is not in a state of being immediately used, and opens the relay 53. Accordingly, it is possible to reduce a risk that the battery 50 after being charged with electricity causes an external short circuit.

### Embodiment 3

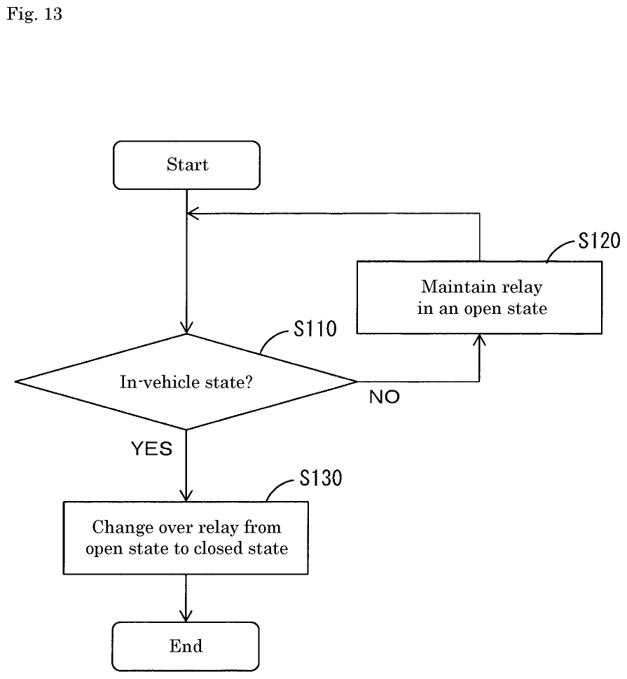

FIG. 13 is a flowchart of the recovery processing.

The recovery processing is processing that is performed when the relay 53 is opened (when step S60 is performed) in the processing of reducing the risk of occurrence of an external short circuit. Hereinafter, the recovery processing is described with respect to the first battery 50A. Before the recovery processing is started, the first battery 50A is in a not-in-vehicle state and is charged with electricity, and the relay 53 is open.

The recovery processing includes three steps of consisting of steps S110 to S130. In step S110, the control unit 130 determines whether or not the first battery 50A is “in an in-vehicle-state”.

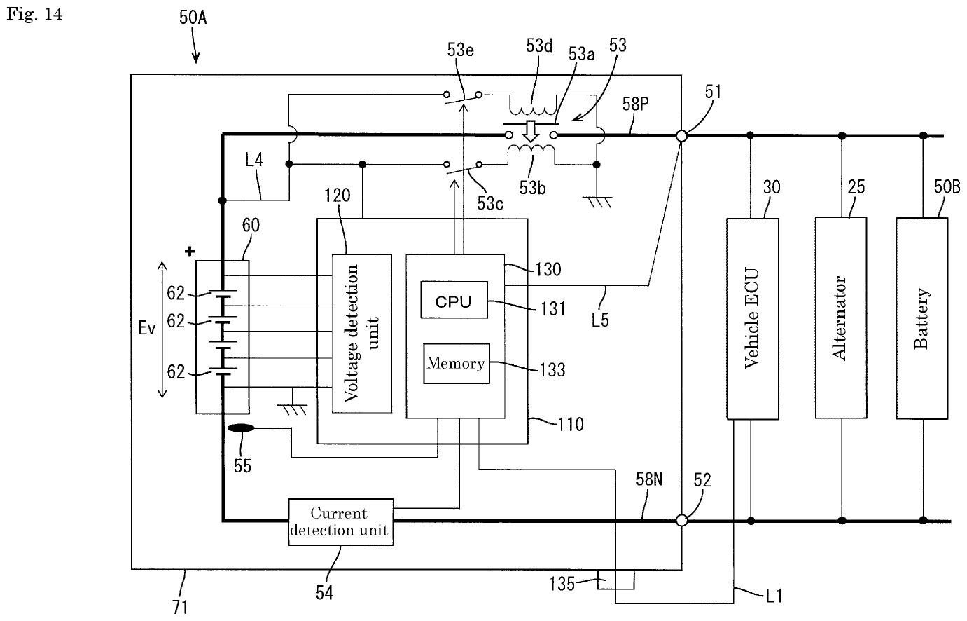

The control unit 130 can determine whether or not the battery 50 is “in an in-vehicle state” based on whether or not the communication between the control unit 130 and the vehicle ECU 30 is restarted. The control unit 130 can also make such determination based on a change in voltage of the external terminal 51. FIG. 14 is a block diagram of the battery 50A having a function of measuring a voltage of the external terminal 51. Symbol L5 illustrated in FIG. 14 is a signal line that detects a voltage of the external terminal 51.

When “a not-in-vehicle state” continues, the determination “NO” is made in step S110. In this case, the processing advances to step S120 and the control unit 130 maintains the relay 53 in an open state.

When the first battery 50A is “in an in-vehicle state”, the determination “YES” is made in step S110. In this case, the processing advances to step S130, and the control unit 130 changes over the relay 53 from an open state to a closed state.

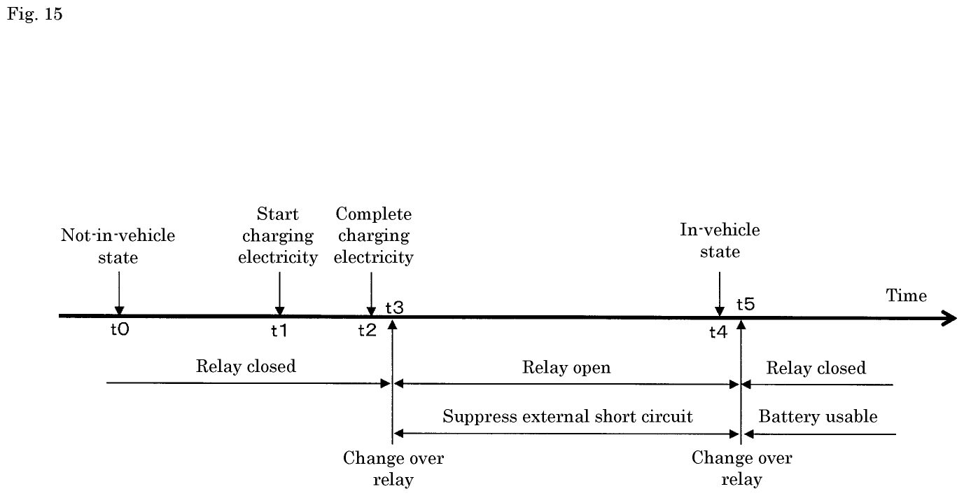

In the above-mentioned configuration, when the first battery 50A is in an in-vehicle state, as illustrated in FIG. 15, the control unit 130 automatically closes the relay 53 so that the first battery 50A can be used immediately. Accordingly, it is unnecessary to perform an operation of closing the relay 53 after the first battery 50A is mounted on the vehicle and hence, it is possible to save the user's time and efforts for such an operation.

### OTHER EMBODIMENTS

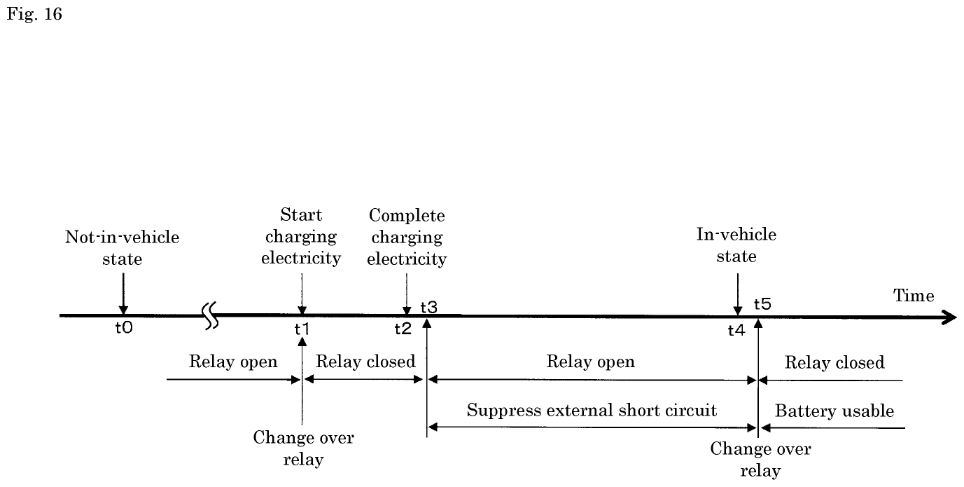

The present invention is not limited to the embodiments described with reference to the above description and drawings. For example, the following embodiments are also included in the technical scope of the present invention.
(1) In embodiment 1, the “processing for reducing the risk of occurrence of an external short circuit” illustrated in FIG. 10 is performed with respect to the first battery 50A out of the first battery 50A and the second battery 50B. The same processing may be performed also with respect to the second battery 50B. The same processing may be performed with respect to both of two batteries 50A and 50B. The same goes for other embodiments.
(2) In embodiment 1, as an example of the relay 53, a relay of a latch type capable of holding the contact 53a has been described. The relay 53 is not limited to a relay of a latch type. The relay 53 may be a relay having no latch function. The same goes for other embodiments.
(3) In embodiment 1, the relay 53 having a mechanical contact has been described as an example of the current interruption device. The current interruption device is not limited to a relay. A semiconductor switch such as a bipolar transistor, an FET or the like may be used as the current interruption device. The same goes for other embodiments.
(4) The secondary battery cell 62 is not limited to a lithium ion secondary battery, and may be a secondary batteries such as a nonaqueous electrolyte secondary battery. A lead-acid battery cell may also be used. The secondary battery cells 62 are not limited to be connected in series and in parallel, and may be connected in series or may be formed of a single cell. A capacitor may be used in place of the secondary battery cell 62. The secondary battery cell or the capacitor is an example of the energy storage cell. The same goes for other embodiments.
(5) In embodiment 1, the communication between the automobile 10 and the battery 50 is performed in a wired manner. However, the communication may be performed in a wireless manner. The same goes for other embodiments.
(6) In embodiment 1, the control unit 130 determines whether the first battery 50A is in an in-vehicle state or in a not-in-vehicle state “after the completion of charging of electricity”. The determination of an in-vehicle state or a not-in-vehicle state may be performed “before starting charging of electricity”. The same goes for other embodiments.
(7) In embodiment 1, the state of the relay 53 before starting charging of electricity is in a “closed” state. The state of the relay 53 before starting charging of electricity may be either an open state or a closed state. As illustrated in FIG. 16, the state of the relay 53 before starting charging of electricity may be in an “open” state. The relay 53 may be changed over from an “open state” to a “closed state” by detecting charging of electricity.
(8) In embodiment 1, the first battery 50A is used for starting the engine, and the second battery 50B is used for operating the auxiliary machine (for operating the load). The usages of these two batteries 50A, 50B are not limited to the example described in the embodiment. Alow voltage use (a 12V system) and a high voltage use (a 48V system) may be named as the usages of two batteries. Two batteries 50A, 50B may be used for driving a vehicle and for a vehicle system. Further two batteries having the same usage may be provided for a redundancy purpose.
(9) In embodiment 3, the relay 53 is automatically closed when an in-vehicle state of the first battery 50A is detected. The closing of the relay 53 may be manually performed by a user. For example, the user may close the relay 53 using an external switch that the user can operate from the outside. In a case where the relay 53 does not include an automatic recovery function, the automobile 10 may be a one-power source type where only one battery 50 is mounted on the automobile 10.
(10) In the above-mentioned embodiment 1, the battery 50 is a battery for an automobile. However, the battery 50 is not limited to a battery for an automobile, and may be used in a motorcycle. The battery 50 can be used as a battery for a vehicle such as an automobile or a motorcycle. Further, the battery 50 can be used in other usages other than a vehicle. For example, the battery 50 can be also used as a stationary battery such as an uninterruptible power system or an energy storage apparatus for a power generating system. The same goes for other embodiments.
(11) The present technique can be implemented based on the following modes.

An energy storage apparatus includes: an energy storage cell; a current interruption device that interrupts a current to the energy storage cell; and a control unit. The control unit controls opening/closing of the current interruption device depending on a state of the energy storage apparatus after being charged with electricity. For example, the current interruption device may be closed when the energy storage apparatus is in a first state, and the current interruption device may be opened when the energy storage apparatus is in a second state where the risk of the occurrence of an external short circuit is higher than the risk of occurrence of an external short circuit in the first state. With respect to the specific examples of the first state and the second state, in a case of an in-vehicle energy storage apparatus, the first state is an in-vehicle state (the first state), and the second state is in a not-in-vehicle state (the second state). In the case of a stationary energy storage apparatus, the first state is a state in which the energy storage apparatus is mounted on a facility such as a UPS, and the second state is a state in which the energy storage apparatus is not mounted on the facility such as the UPS.

### DESCRIPTION OF REFERENCE SIGNS

10: automobile
30: vehicle ECU (vehicle control device)
50A: first battery (energy storage apparatus)
50B: second battery (energy storage apparatus)
53: relay (current interruption device)
54: current detection unit
60: assembled battery
110: management device
130: control unit

1. An in-vehicle energy storage apparatus comprising:
an energy storage cell;
a current interruption device configured to interrupt a current to the energy storage cell; and
a control unit,
wherein the control unit is configured to, in a case where the energy storage apparatus is charged with electricity in a not-in-vehicle state, interrupt the current to the energy storage cell by the current interruption device after the energy storage apparatus is charged with electricity.

2. The in-vehicle energy storage apparatus according to claim 1, wherein the control unit is configured to determine whether the energy storage apparatus is in an in-vehicle state or in the not-in-vehicle state after the energy storage apparatus is charged with electricity.

3. The in-vehicle energy storage apparatus according to claim 1, wherein the control unit is configured to determine whether the energy storage apparatus is in an in-vehicle state or in the not-in-vehicle state based on communication between the energy storage apparatus and a vehicle.

4. The in-vehicle energy storage apparatus according to claim 1, wherein the control unit is configured to release interruption of a current by the current interruption device in a case when the energy storage apparatus is mounted on a vehicle during the interruption of the current.

5. An energy storage apparatus comprising:
an energy storage cell;
a current interruption device configured to interrupt a current to the energy storage cell; and
a control unit,
wherein the control unit is configured to control opening/closing of the current interruption device depending on a state of the energy storage apparatus after being charged with electricity.

6. A method of controlling a current interruption device used in an in-vehicle energy storage apparatus, wherein in a case where the energy storage apparatus is charged with electricity in a not-in-vehicle state, a current to an energy storage cell is interrupted by the current interruption device after the energy storage apparatus is charged with electricity.
